(19) United States
(12) Patent Application Publication
(10) Pub. No.: US 2009/0288615 A1
(43) Pub. Date: Nov. 26, 2009

(54) MAT FOR HANDLING SAND FOR PET

(76) Inventor: Toshifumi Fukunishi, Osaka (JP)

Correspondence Address: BIRCH STEWART KOLASCH & BIRCH, PO BOX 747, FALLS CHURCH, VA, 22040-0747, US

(21) Appl. No.: 12/161,304

(22) PCT Filed: May 22, 2008
(86) PCT No.: PCT/JP2007/071694

§ 371 Date: Jul. 17, 2008

(30) Foreign Application Priority Data
Nov. 14, 2006 (JP) 2006 307811

(51) Int. Cl. A01K 13/00; A01K 1/015

(52) U.S. Cl. 119/621; 119/650

(57) ABSTRACT

A recessed and protruding structure for handling sand for a pet and a mat having the structure, the structure capable of removing sand or the like attached to the pet such as a dog and a cat and especially sand attached to paws of a cat by spreading apart toes without straining them during walking of the pet, is provided. A plurality of protrusions independent of each other at least at their tip end portions are provided on a base portion of the mat. A height of each independent protrusion is greater than 6 mm and smaller than 11 mm, a diameter of each independent protrusion is greater than or equal to 3 mm and smaller than 6 mm, intervals between the independent protrusions are longer than 3 mm and shorter than 9 mm, and toes of paws of the pet spread apart and the sand between the toes falls off when the pet walks on the independent protrusions.

### BACKGROUND OF THE INVENTION

1. Field of the Invention

The present invention relates to a recessed and protruding structure for handling sand for a pet, and a mat having the structure on its surface.

2. Description of the Related Art

Conventionally, there has been proposed a mat laid near a pet toilet for a pet and especially for a cat and having great effect of removing sand.

Japanese Utility Model Registration No. 3040615 (hereinafter, Document 1) discloses a mat having a large number of parallel belt-shaped protruding portions arranged on a sheet and discloses that a mat with the belt-shaped protruding portions having widths of 3 to 30 mm, heights of 3 to 10 mm, and arranged at intervals of 3 to 30 mm can satisfactorily remove sand from paws of a cat. Specifically, paragraph 0015 in the specification describes, “A mat for a pet was formed by disposing and sticking eighteen belt-shaped protruding portions 3 parallel at intervals of 1 cm on a sheet 1 made of kraft paper having a thickness of 0.3 mm, each of the protruding portions 3 being made of mat paper and having a height of 5 mm, a width of 1.5 cm, and a length of 33 cm, while leaving a length of 5 cm of the mat as a portion 4 to be inserted into a pet toilet. A proper amount of small grains of zeolite was spread as cat sand in the pet toilet 5 while using the mat. As a result, a large amount of cat sand that had fallen in groove portions of the mat was observed and the mat could be easily rolled and put in a trash can”.

Japanese Patent Application Publication No. 2000-32860 (hereinafter, Document 2) and Japanese Patent Application Publication No. 2000-209976 (hereinafter, Document 3) disclose an underlying mat for preventing scattering of excrement absorbent granular material (cat sand) contained in a toilet container for a pet around the toilet and for preventing tainting of an area around the toilet by cleaning bottoms of tainted paws of the pet after excretion, the underlying mat provided with a large number of parallel belt-shaped protruding portions similarly to Document 1. In each of these mats, because recessed and protruding portions are formed throughout an area surrounding the toilet for the pet as described in paragraph 0006 in the specification of Document 2, the granular material can be caught in the recessed portions when it rolls out of the toilet. Moreover, taint on the bottoms of the paws of the pet is wiped away with nonwoven fabric in a surface layer and therefore the taint is less liable to adhere to the floor outside the underlying mat.

As described above, the mats in Documents 2 and 3 are for preventing cat sand from rolling out of the mat, and sizes of the recessed and protruding portions are determined based on the commercially available cat sand. Specifically, as described in paragraph 0014 in the specification of Document 2, a dimension of the commercially available granular material 11 (cat sand) is not greater than 3 mm in a case of stone sand, between 4 mm to 6 mm in a case of silica sand, and between 5 mm to 7 mm in a case of sand made of pulp. Therefore, to hold the cat sand in the recessed portion 5, a length and a width of the recessed portion 5 are preferably about 2 to 10 mm and a depth of the groove of the recessed portion is preferably about 2 to 10 mm.

Similarly, paragraph 0017 in the specification of Document 3 describes, “Recesses and protrusions are formed on almost all of the surface of the mat 1 of the invention. In a mat shown in FIG. 2, groove-shaped recessed portions 5 are formed parallel in a surface 4 of the mat 1 and protruding portions 6 are formed between the recessed portions 5”. Paragraph 0019 describes, “Incidentally, sizes of the recessed portion 5 and the protruding portion 5 are properly adjusted. A dimension of the commercially available granular material 11 (cat sand) is not greater than 3 mm in a case of stone sand, between 4 mm to 6 mm in a case of silica sand, and between 5 mm to 7 mm in a case of sand made of pulp. Therefore, to hold the cat sand in the recessed portions 5, a width 5d of the narrowest portion in the recessed portion is about 2 to 10 mm and best preferably about 5 mm and a depth of the groove of the recessed portion is about 2 to 10 mm and best preferably about 5 mm. Moreover, an interval between the recessed portion 5 and the recessed portion 5, i.e., a width 6d of the protruding portion 6 (a width of the widest portion) is about 2 to 10 mm and best preferably about 5 mm. If the dimensions of the recessed and the protruding portions are set as described above, taint on the bottoms of the paws gets caught on the protruding portions 6 and can be removed effectively when the pet walks on the mat 1”.

### BRIEF SUMMARY OF THE INVENTION

It is an object of the present invention to provide a recessed and protruding structure for handling sand for a pet and a mat for the pet and having the structure, the structure capable of further reliably removing sand or the like attached to the pet such as a dog and a cat and especially sand attached to paws of a cat by spreading toes apart without straining them during walking of the pet.

To achieve the above object, according to the present invention, there is provided a recessed and protruding structure for handling sand for a pet, wherein the structure is formed of a plurality of protrusions independent of each other at least at their tip end portions, a height of each independent protrusion is greater than 6 mm and smaller than 11 mm, a diameter of each independent protrusion is greater than or equal to 3 mm and smaller than 6 mm, intervals between the independent protrusions are longer than 3 mm and shorter than 9 mm, and toes of paws of a pet spread apart when the pet walks on the independent protrusions. Moreover, to achieve the above object, according to the present invention, there is provided a mat for handling sand for a pet, the mat provided on its surface with the recessed and protruding structure for handling the sand for the pet.

According to the present invention, the plurality of independent protrusions are arranged. Therefore, when the pet walks on the independent protrusions, the bottoms of the paws of the pet are pressed by the independent protrusions and the toes of the paws naturally spread apart. As a result, the sand caught between the toes of the paws falls off. More preferably, the independent protrusions enter between the spread toes of the paws to thereby further reliably spread apart the toes to facilitate falling off of the sand.

### BRIEF DESCRIPTION OF THE DRAWINGS

FIG. 1(A) is a plan view showing a state of use of a mat for handling sand for a pet according to an embodiment of the present invention, FIG. 1(B) is a plan view showing a state of use of a mat for handling the pet sand according to another embodiment, and FIG. 1(C) is a plan view showing a state of use of a mat for handling the pet sand according to yet another embodiment.

FIG. 2(A) is a sectional view of an essential portion of FIG. 1(A), and FIG. 2(B) is a perspective view of the portion.

FIG. 3 is an explanatory view showing a state in which a cat is stepping on the mat for handling the pet sand according to the embodiments of the present invention.

### DETAILED DESCRIPTION OF PREFERRED EMBODIMENTS

Embodiments of the invention of the present application will be described based on the drawings.

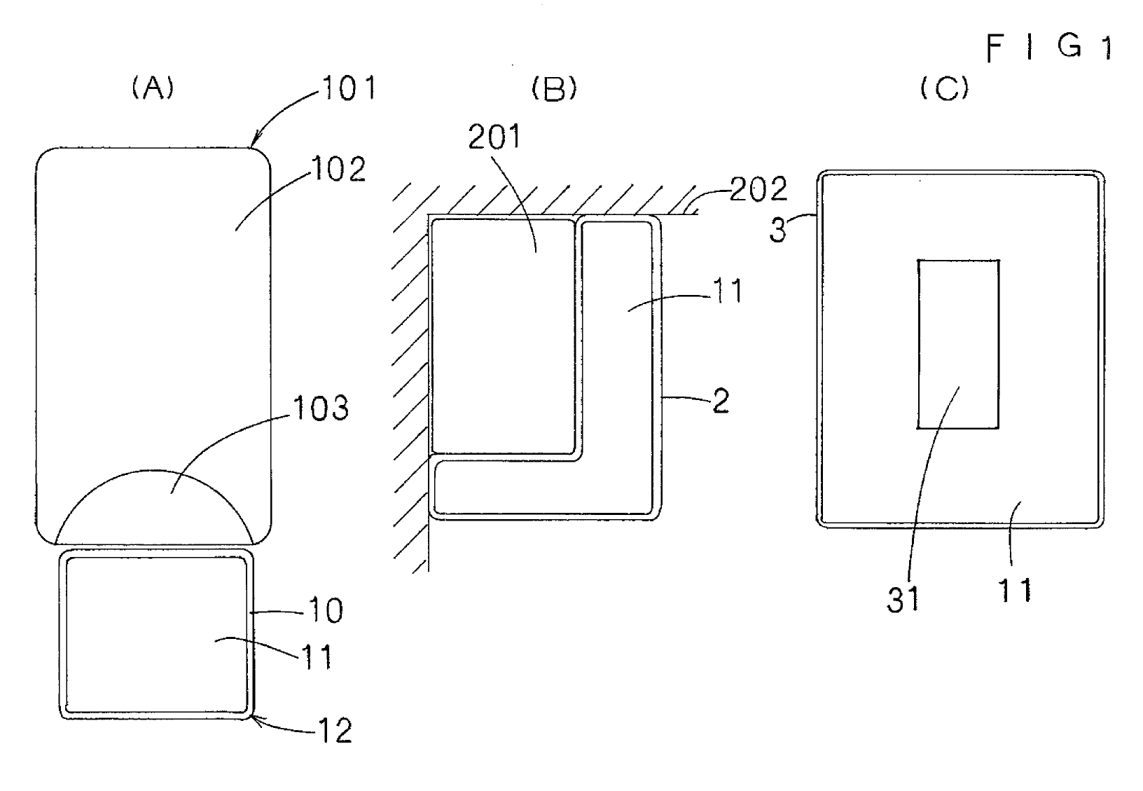

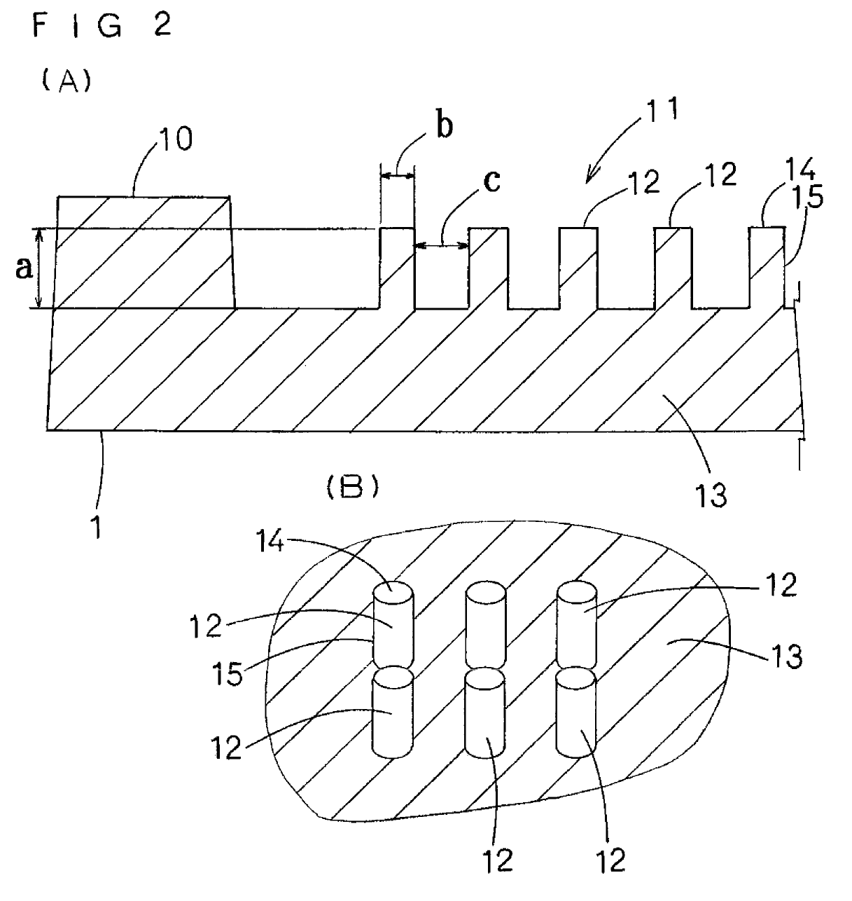

FIG. 1(A) is a plan view showing a state of use of a mat for handling sand for a pet according to an embodiment of the present invention, FIG. 1(B) is a plan view showing a state of use of a mat for handling the pet sand according to another embodiment, and FIG. 1(C) is a plan view showing a state of use of a mat for handling the pet sand according to yet another embodiment. FIG. 2(A) is a sectional view of an essential portion of FIG. 1(A) and FIG. 2(B) is a perspective view of the portion.

The mat 1 shown in FIG. 1(A) is for preventing sand (natural sand or excrement absorbent granular material contained in a toilet container for a pet) attached mainly to paws of a cat from being brought from the toilet to an area around the toilet while attached to the paws of the cat by helping the sand fall off the paws of the cat on the mat 1. The mat 1 is laid around the toilet for the cat. In this embodiment, the mat 1 is disposed in front of an entrance 103 of the toilet 101 which is covered with a cover 102 and in which the sand is placed. The mat of such a size that the cat can take few steps on it suffices. Specifically, one side may be about 20 to 100 cm long and preferably 30 to 50 cm long. A rectangle or a square is suitable as a planar shape of the mat, but the shape may be other polygons or may be appropriately changed to an ellipse, a circle, and the like.

A recessed and protruding structure 11 for handling the pet sand shown in FIGS. 2(A), 2(B) is formed on almost all of a surface of the mat 1. The recessed and protruding structure 11 will be described later. Moreover, a ridge portion 10 is formed throughout an outer periphery of the surface of the mat 1 to prevent the sand scraped off by the recessed and protruding structure 11 for handling the pet sand from falling out of the mat 1.

Although the mat 2 shown in FIG. 1(B) is different from the previous embodiment in that its planar shape is an L shape, the mat 2 is substantially the same as the previous embodiment in other structures. The mat 2 is L-shaped and therefore suitable for a toilet 201 without a cover and accessible for the cat from any direction. The mat can be laid along two sides of the toilet 201 disposed in a corner of a wall 202. Although it is not shown in the drawing, two mats 2 may be combined into a rectangle.

The recessed and protruding structure 11 for handling the pet sand shown in FIGS. 2(A), 2(B) is formed on almost all of a surface of the mat 2. The recessed and protruding structure 11 will be described later.

The mat 3 shown in FIG. 1(C) is formed with the recessed and protruding structure 11 for handling the pet sand shown in FIGS. 2(A), 2(B) around its flat central portion 31. A toilet is placed on the central portion 31.

As can be understood from the above embodiments, the shape of the mat can be changed appropriately on condition that the mat can be laid in a position where the cat walk. Although it is not shown in the drawing, the mat may be formed as a long sheet-shaped body and sold in a rolled state and a user may cut the mat to appropriate dimensions to use it. Material of these mats 1, 2, 3 is not especially limited and any of synthetic resin, rubber, paper, nonwoven fabric, metal, wood, and the like may be selected and used appropriately. Material that can be used repeatedly and having high durability may be used or disposable material may be used. Although the mat is the most suitable for the area around the cat toilet, the place where the mat is laid is not limited to it but may be changed in various ways such as vicinities of a feeding site, a house door, and the like. The back faces of the mats 1, 2, 3 may be provided with slip stoppers as necessary similarly to normal mats and sheets.

On the surface of each of the mats 1, 2, and 3, the recessed and protruding structure 11 for handling pet sand and formed of a large number of independent protrusions 12 shown in FIGS. 2(A), 2(B) is provided. The recessed and protruding structure 11 is formed of a base portion 13 and a plurality of independent protrusions 12 in shapes of columns protruding upward from the base portion 13 and independent of each other at least at their tip end portions. These independent protrusions 12 are disposed at predetermined intervals with their tip ends oriented upward. The cat walks on these many independent protrusions 12, the toes of the paws of the cat are spread apart during the walk, and the sand between the toes of the paws falls.

The shape of the independent protrusion 12 is preferably the column (and especially a circular column) as shown in FIG. 2(B). An edge between an upper face 14 and a side face 15 is preferably chamfered, and a top portion may be formed into a substantially spherical shape such as a hemisphere. The protrusion 12 may be a prism having a polygonal shape in a plan view or may have an elliptic shape in a plan view. In the case of the polygonal shape, a pentagon or a more polygonal shape is preferable because the cat feels pain by corners of a triangle or a square having fewer corners. However, the triangle may be employed if it is chamfered. A cone or a pyramid having a pointed tip is not preferable because it may cause pain to the cat, but an unpointed truncated cone or truncated pyramid may be employed. It is also possible to form the whole independent protrusion 12 as a hemispherical protrusion.

The respective independent protrusions 12 have to stand substantially independently instead of being contiguous ridges. However, it is possible to connect portions near base portions of the respective independent protrusions 12 by ribs to increase strength. In this case, tip ends of the respective independent protrusions 12 are still independent.

Although dimensions of the independent protrusion 12 may be changed in various ways according to the type and size of pet, the following dimensions are appropriate if the mat is intended for cats or dogs kept indoors.

First, height a of the independent protrusion 12 greater than 6 mm and smaller than 11 mm is appropriate. If the height of the independent protrusion 12 is not greater than 6 mm, the toes of the cat do not spread apart and the sand between the toes is less liable to fall off. On the other hand, if the height of the independent protrusion 12 is 11 mm or greater, the protrusion bites into a membrane between the toes and it is highly possible that the cat feels pain and stops walking on the protrusions. The heights of all the independent protrusions 12 need not be mathematically equal but may be substantially equal. It is possible to arrange the protrusions having mathematically different heights.

With regard to a size b of the independent protrusion 12 (a size in a plan view), a diameter (the longest distance between two points on an outer peripheral portion in a case of a shape other than the circle) greater than or equal to 3 mm and smaller than 6 mm is appropriate. If the diameter is smaller than 3 mm, the cat does not strongly feel the independent protrusion 12 when it enters between the toes of the cat and therefore the toes do not spread apart sufficiently and the sand does not fall off. On the other hand, if the diameter is greater than or equal to 6 mm, it is highly possible that the cat feels pain and stops walking on the protrusions.

The interval c between the independent protrusions 12 is preferably longer than 3 mm and shorter than 9 mm. The interval not longer than 3 mm is inappropriate, because the independent protrusion 12 does not enter between the toes and the toes do not spread apart. On the other hand, if the interval is longer than or equal to 9 mm, the interval between the independent protrusions 12, 12 is too long to allow the protrusions to enter between the respective toes and therefore not all toes may spread apart. The arrangement of the independent protrusions 12 may be a grid-like arrangement in which the protrusions 12 are arranged on vertexes of squares or an arrangement in which the protrusions are arranged on vertexes of equilateral triangles and may be changed properly.

The recessed and protruding structure 11 for handling the pet sand and having the above-described independent protrusions 12 can be employed as a surface profile of a mat or the recessed and protruding structure 11 can be employed at a periphery of a pet toilet.

### EXAMPLES

Although examples of the present invention will be described below, it should be understood that the present invention is not limited to the examples.

The mat 1 shown in FIGS. 1(A) to 2(B) was made of wood. The shape of the protrusion was a circular column having a diameter of 4 mm. The interval between the protrusions was 6 mm and the height of the protrusion was changed as shown in Table 1 (the protrusions were ground with sandpaper so that the height was successively reduced). The mats having the respective heights were laid at the entrance of the toilet, a mature cat was kept, and the mat of each height was observed for two days. As observation items, all of an amount of sand on the mat 1, an amount of sand on the floor of a room where the toilet is disposed, an attached state of sand to bottoms of paws of the cat, and behavior of the cat were observed and evaluated to thereby rate the mat based on the following 3-grade evaluation. The result is shown in Table 1.

A: Great effect of scraping the sand
B: Moderate effect of scraping the sand
C: No effect of scraping the sand

TABLE 1

| | Heights of protrusions | | | | | | | |
|---|---|---|---|---|---|---|---|---|
| | 12 mm | 11 mm | 10 mm | 9 mm | 8 mm | 7 mm | 6 mm | 5 mm |
| Grade | C | C | B | A | B | B | C | C |

### DISCUSSION

The mats having the heights of 12 mm and 11 mm had no effect, because the cat gave an indication that it had felt pain and walked around the mats. The mats having the heights of 6 mm and 5 mm did not sufficiently spread apart the toes.

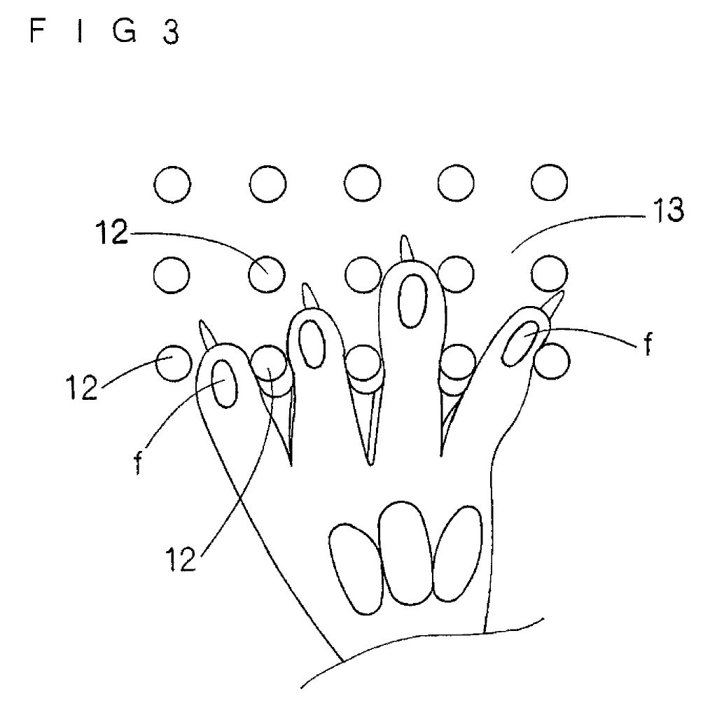

Next, a large number of circular columnar protrusions having heights of 9 mm and diameters of 4 mm were formed and arranged at predetermined intervals on cork boards. A paw of a mature cat was placed on them a plurality of times and change of the paw was observed. As shown in FIG. 3, the board with the protrusions 12 which had entered between all of the toes f without straining them to spread them apart substantially every time was rated as A, the board with the protrusions 12 which had substantially spread apart the toes (e.g., the protrusions 12 had entered between the toes f but not always and not between all of the toes f) was rated as B, and the board with protrusions which had not spread apart the toes was rated as C and shown in Table 2.

TABLE 2

| | Intervals between | | | | | | | |
|---|---|---|---|---|---|---|---|---|
| | protrusions | | | | | | | |
| | 2 mm | 3 mm | 4 mm | 5 mm | 6 mm | 7 mm | 8 mm | 9 mm |
| Grade | C | C | B | B | A | A | B | C |

Next, circular columnar protrusions having heights of 9 mm and diameters of 3 to 6 mm were arranged at intervals of 6 mm on cork boards. A paw of a mature cat was placed on them and change of the paw was observed. The board with the protrusions 12 which had entered between the respective toes without straining them to facilitate spreading apart of them was rated as A, the board with the protrusions 12 which had substantially spread the toes was rated as B, and the board with protrusions which had caused pain and had not spread apart the toes was rated as C and shown in Table 3.

TABLE 3

Diameters of protrusions

| | 3 mm | 4 mm | 5 mm | 6 mm |
|---|---|---|---|---|
| Grade | B | A | B | C |

As described above, with the present invention, it is possible to satisfactorily scrape the sand attached to the paws by utilizing the habit of the pet such a cat and a dog.

1. A product for handling sand for a pet, wherein the product is provided on a surface thereof with a plurality of protrusions independent of each other at least at their tip end portions, a height of each independent protrusion is greater than 6 mm and smaller than 11 mm, a diameter of each independent protrusion is greater than or equal to 3 mm and smaller than 6 mm, intervals between the independent protrusions are longer than 3 mm and shorter than 9 mm, and toes of paws of a pet spread apart when the pet walks on the independent protrusions.

2. A mat for handling sand for a pet, wherein the mat is provided on a surface thereof with a plurality of protrusions independent of each other at least at their tip end portions, a height of each independent protrusion is greater than 6 mm and smaller than 11 mm, a diameter of each independent protrusion is greater than or equal to 3 mm and smaller than 6 mm, intervals between the independent protrusions are longer than 3 mm and shorter than 9 mm, and toes of paws of a pet spread apart when the pet walks on the independent protrusions.
